(19) United States
(12) Patent Application Publication
(10) Pub. No.: US 2025/0296286 A1
(43) Pub. Date: Sep. 25, 2025

(54) CONTONE LEVEL ADJUSTMENTS TO COMPENSATE FOR GEOMETRICAL DEVIATIONS

(71) Applicant: Peridot Print LLC, Palo Alto, CA (US)

(72) Inventors: Sergio Gonzalez Martin, Sant Cugat del Valles (ES); Manuel Freire Garcia, Sant Cugat del Valles (ES); Alejandro Manuel de Pena Hempel, Sant Cugat del Valles (ES); Ismael Fernandez Aymerich, Sant Cugat del Valles (ES)

(21) Appl. No.: 19/233,678

(22) Filed: Jun. 10, 2025

Related U.S. Application Data
(63) Continuation of application No. 17/823,767, filed on Aug. 31, 2022, now abandoned.

(51) Int. Cl. B29C 64/393; B29C 64/165; B33Y 10/00; B33Y 30/00; B33Y 50/02

(52) U.S. Cl. CPC B29C 64/393; B33Y 50/02; B29C 64/165; B33Y 10/00; B33Y 30/00

(57) ABSTRACT

In some examples, a system receives measurement data from measurements of first three-dimensional (3D) parts formed on a build bed of an additive manufacturing machine with different contone levels of a liquid agent, and determines, based on the measurement data, geometrical deviations of the first 3D parts from a baseline geometrical property. The system generates, based on the determined geometrical deviations, a model that correlates contone levels of the liquid agent to corresponding geometrical deviations, the model for use in an adjustment of the liquid agent based on a contone level adjustment to compensate for a geometrical deviation when building second 3D parts with the additive manufacturing machine or another additive manufacturing machine.

### BACKGROUND

Additive manufacturing machines produce three-dimensional (3D) parts by building up layers of build material, including a layer-by-layer accumulation and solidification of the build material patterned from computer aided design (CAD) models or other digital representations of physical 3D parts to be formed. A type of an additive manufacturing machine is referred to as a 3D printing system. Each layer of the build material is patterned into a corresponding portion (or portions) of the 3D part.

### BRIEF DESCRIPTION OF THE DRAWINGS

Some implementations of the present disclosure are described with respect to the following figures.

FIG. 1 is a block diagram of an arrangement that includes an additive manufacturing machine and a contone adjustment model generation engine to generate a model for contone level adjustment to compensate for geometrical deviations of three-dimensional (3D) parts built by the additive manufacturing machine, according to some examples.

FIG. 2 is a schematic diagram illustrating formation of 3D parts in different build regions of a build bed as part of a calibration job, according to some examples.

FIG. 3 is a graph relating contone levels to geometrical adjustments provided by different control levels, according to some examples.

FIG. 4 is a block diagram of a storage medium storing machine-readable instructions according to some examples.

FIG. 5 is a block diagram of a system according to some examples.

FIG. 6 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

Additive manufacturing machines can be used to build various articles. As examples, the articles can include human wearable products such as footwear, dental prosthetics, gloves, clothing, splints, headwear, and so forth. As other examples, the articles can include products that are provided to support a user, such as seat cushions, child seats, mattresses, braces, splints, and so forth. More generally, additive manufacturing machines can build three-dimensional (3D) parts.

In some examples, a build material used by an additive manufacturing machine such as a 3D printing system can include a powdered build material that is composed of particles in the form of fine powder or granules. The powdered build material can include plastic particles, polymer particles, ceramic particles, glass particles, or particles of other powder-like materials.

As part of the processing of each layer of build material, liquid agents can be dispensed by liquid agent dispensers (such as through a printhead or another fluid dispensing device) of the additive manufacturing machine onto the layer of build material. In some examples, the applied liquid agents can include a fusing agent (which is a form of an energy absorbing agent including, for example, carbon black particles) that absorbs heat energy emitted from an energy source used in the additive manufacturing process. For example, after a build material layer is deposited onto a build platform (or onto a previously formed build material layer) in the additive manufacturing machine, a fusing agent with a target pattern can be deposited onto portions of the build material layer, to assist in melting of the build material layer portions.

The target pattern can be based on an object model (or more generally, a digital representation) of a physical 3D part that is to be built by the additive manufacturing machine. The digital representation of the 3D part can include a computer aided design (CAD) model, which can have any of various formats, such as a Standard Tessellation Language (STL) format, an OBJ format, an Additive Manufacturing File (AMF) format, a 3D Manufacturing Format (3MF), and so forth.

The portions of the build material layer onto which the fusing agent is deposited will be heated to a higher temperature than other portions of the build material layer without the fusing agent. Heat energy is applied to heat up the build material layer portions for melting. The melted build material layer portions then coalesce and solidify upon cooling.

Another liquid agent that can be applied to a build material layer is a detailing agent, which does not absorb heat energy emitted from the energy source. In some examples, the detailing agent can be applied to an edge boundary portion of the areas in which the fusing agent is deposited, to provide a cooling effect at the edge boundary portion. The presence of the detailing agent combats the effect of coalescence bleed caused by fusing due to heating in adjacent portions of the build material layer. The detailing agent can thus help in defining more accurate boundary portions of a 3D part.

An additive manufacturing machine can form a collection of 3D parts (a single 3D part or multiple 3D parts) on a build bed. A “build bed” refers to an area of the additive manufacturing machine in which an additive manufacturing process is performed to build the collection of 3D parts on a layer-by-layer basis. Initially, before any layer of build material is applied, the build bed can include the upper surface of a build platform of the additive manufacturing machine. A first layer of build material is spread over the build platform, and the first layer of build material is then processed by applying liquid agent(s) followed by heating the first layer of build material (and possibly other processing action(s)). At this point, the build bed includes the upper surface of the first layer of build material. Subsequently, further layers of build material are deposited and processed, which builds up the collection of 3D parts on a layer-by-layer basis. The build bed for each iteration of build material layer spreading and processing is the upper surface of the 3D part(s) formed by the processing of prior layer(s) of build material.

In some cases, thermal non-uniformity may occur across the build bed during an additive manufacturing process, which includes heating and cooling of layers of build material. Thermal non-uniformity causes temperatures in different regions of the build bed to vary, even though the different regions of the build bed should be at the same target temperature. For example, thermal non-uniformity may cause a first region of the build bed to be hotter than a second region of the build bed. The temperature variation across the build bed can cause properties of 3D parts formed in the different regions of the build bed to vary from a target specification. For example, geometrical properties of the 3D parts can vary, where examples of geometrical properties can include any or some combination of the following: a size, a thickness, a curvature dimension such as a radius or diameter, or any other geometrical property that affects a collection of dimensions (a single dimension or multiple dimensions) of the 3D parts.

Geometrical properties of 3D parts may also vary due to other factors, such as due to geometries of the 3D parts themselves. For example, a build job for an additive manufacturing machine may specify that a first 3D part formed in a first region of a build bed is different from a second 3D part formed in a second region of the build bed. As examples, the first and second 3D parts may have different shapes, sizes, and so forth. The different geometries of different 3D parts during a build job can result in temperatures varying differently from a target specification when processing build material layers for the different 3D parts.

More generally, geometrical properties of 3D parts can vary due to any of various physical effects during an additive manufacturing process to form the 3D parts.

In some examples, compensation for expected variations in geometrical properties of 3D parts to be formed by an additive manufacturing machine may be performed by introducing adjustments during a voxelization process. The voxelization process converts an object model of a 3D part into a voxel-based representation of the 3D part, which defines properties of the 3D part on a voxel-by-voxel basis. The voxel-based representation of the 3D part includes a 3D arrangement of voxels, where each voxel can be associated with properties of a portion of the 3D part to be built. A “voxel” defines a volume unit in 3D space. The properties associated with each voxel can include strength, appearance, feature detail, and so forth.

More specifically, to compensate for expected variations in geometrical properties of a 3D part, properties of surface voxels of the 3D part may be adjusted. A “surface voxel” (or “shell voxel”) refers to a voxel at the outermost surface of the 3D part. The surface voxel is discretized when the 3D part is built-discretizing the surface voxel refers to either forming the 3D part with the surface voxel or without the surface voxel. As a result of discretization of surface voxels, dimensional control of the surface voxels is lost; in other words, an additive manufacturing machine is unable to build a surface of the 3D part at less than a dimension of an entire surface voxel (i.e., on a sub-voxel basis in which control of a portion of the 3D part is performed on a scale that is less than the dimension of the voxel). Thus, even though adjustments are introduced during voxelization of an object model in an attempt to compensate for expected variations in geometrical properties of the 3D part, discretization errors can cause geometrical adjustments of the 3D part to be imprecise.

In accordance with some implementations of the present disclosure, contone level adjustments based on a contone adjustment model are performed to compensate for expected geometrical deviations of 3D parts to be built by an additive manufacturing machine. The contone adjustment model correlates contone levels of a liquid agent to corresponding geometrical deviations. A contone level of a liquid agent (e.g., a fusing agent, a detailing agent, etc.) defines a corresponding quantity of the liquid agent to be applied during an additive manufacturing process. As examples, the contone levels of the liquid agent can range between 0 and 255, with 0 specifying a minimum quantity of the liquid agent and 255 specifying a maximum quantity of the liquid agent, and any value between 0 and 255 specifying an intermediate quantity of the liquid agent between the minimum and maximum quantities. In other examples, a different range of contone levels of a liquid agent may be defined.

In some examples, the contone adjustment model is derived based on building test 3D parts using different contone levels of a liquid agent, and measuring the test 3D parts to determine geometrical deviations due to application of the different contone levels.

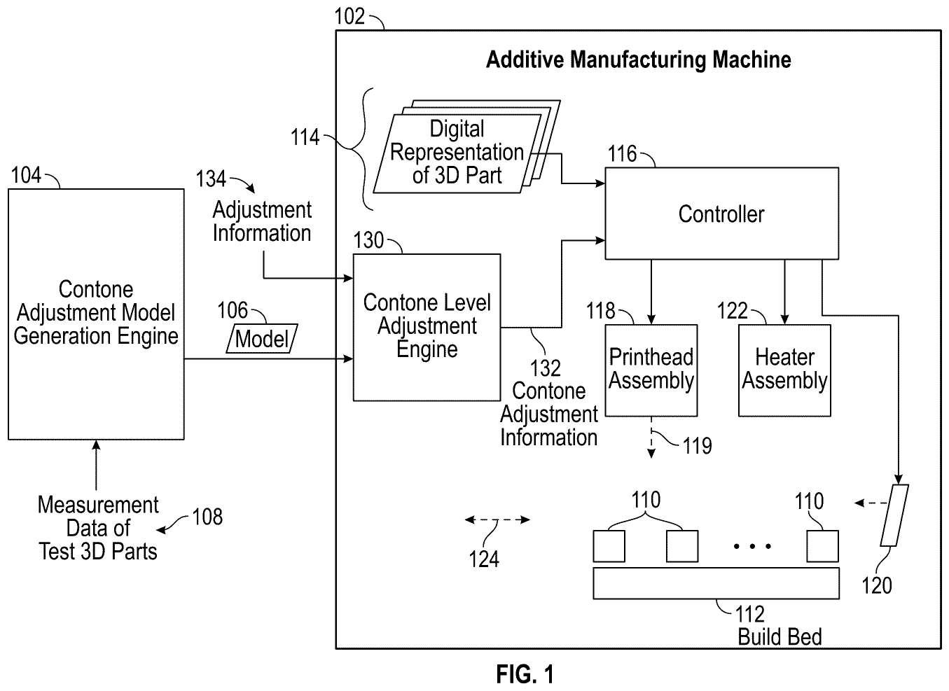

FIG. 1 is a block diagram of an example arrangement that includes an additive manufacturing machine 102 and a contone adjustment model generation engine 104 that produces a contone adjustment model 106 that correlates contone levels of a liquid agent used by the additive manufacturing machine 102 to corresponding geometrical deviations. The contone adjustment model 106 can be in the form of a mapping table, a graph, an equation, or any other data structure or other representation that correlates contone levels of a liquid agent (or multiple liquid agents) to corresponding geometrical deviations

As used here, an “engine” can refer to a hardware processing circuit, which can include any or some combination of a microprocessor, a core of a multi-core microprocessor, a microcontroller, a programmable integrated circuit, a programmable gate array, or another hardware processing circuit. Alternatively, an “engine” can refer to a combination of a hardware processing circuit and machine-readable instructions (software and/or firmware) executable on the hardware processing circuit.

In some examples, the contone adjustment model generation engine 104 is external of the additive manufacturing machine 102. For example, the contone adjustment model generation engine 104 can be implemented with a computer (or multiple computers). In other examples, the contone adjustment model generation engine 104 can be part of the additive manufacturing machine 102.

A “geometrical deviation” refers to a geometrical property error (or difference) of a portion of a 3D part from a baseline geometrical property, where the baseline geometrical property represents a target geometrical property value (e.g., a size, a thickness, a curvature dimension, etc.) of the portion of the 3D part if no error is present.

The contone adjustment model 106 can be used by the additive manufacturing machine 102 to make adjustments of geometrical properties of 3D parts on a sub-voxel basis. In other words, based on adjusting contone levels of a liquid agent (or multiple liquid agents), geometrical properties of a 3D part can be adjusted on a scale that is less than the size of a voxel in a voxel-based representation of the 3D part to be built by the additive manufacturing machine 102.

The contone adjustment model generation engine 104 receives measurement data 108 of test 3D parts built during a calibration job. The test 3D parts may be built by the additive manufacturing machine 102 or a different additive manufacturing machine. Based on the measurement data 108 of the test 3D parts, the contone adjustment model generation engine 104 is able to determine the geometrical deviations of the test 3D parts from a baseline geometrical property. Based on the determined geometrical deviations, the contone adjustment model generation engine 104 is able to generate the contone adjustment model 106.

The contone adjustment model 106 is provided by the contone adjustment model generation engine 104 to the additive manufacturing machine 102, for use by the additive manufacturing machine 102 in performing contone level adjustments for compensating for expected geometrical deviations of 3D parts 110 formed in different regions of a build bed 112 of the additive manufacturing machine 102.

The 3D parts 110 can be built by the additive manufacturing machine 102 based on a collection of digital representations of 3D parts 114, such as CAD models or other types of digital representations of 3D parts. The collection of digital representations of 3D parts 114 can include a single digital representation or multiple digital representations. For example, the multiple digital representations of 3D parts may specify different types of 3D parts to be formed on the build bed 112 in a given build job of the additive manufacturing machine 102.

The collection of digital representations of 3D parts 114 is provided to a controller 116 of the additive manufacturing machine 102. The controller 116 can include a hardware processing circuit or a combination of the hardware processing circuit and machine-readable readable instructions executable on the hardware processing circuit.

The controller 116 can control, based on the collection of digital representations of 3D parts 114, the building of the 3D parts 110 during a build job. The 3D parts 110 are formed in different regions of the build bed 112.

The additive manufacturing machine 102 includes a printhead assembly 118 that is able to dispense a liquid agent 119 (or multiple liquid agents) during a build operation. The liquid agent(s) 119 can include any or some combination of the following: a fusing agent, a detailing agent, or another type of liquid agent.

The additive manufacturing machine 102 also includes a spreader 120 that is able to spread a build material onto the build bed 112. The spreader 120 can include a blade, a roller, or any other structure that is able to form a layer of build material on the build bed 112.

During a build operation, the spreader 120 can spread successive layers of build material onto the build bed 112. Each layer of build material is processed individually, based on application of the liquid agent(s) 119 by the printhead assembly 118.

The additive manufacturing machine 102 also includes a heater assembly 122 that can be activated to apply heat to each layer of build material after the liquid agent(s) has (have) been applied.

The printhead assembly 118 can include a collection of printheads (a single printhead or multiple printheads), where each printhead has an array of nozzles through which the liquid agent(s) 119 can be ejected onto a layer of build material on the build bed 112.

The heater assembly 122 can include a collection of heating lamps (a single heating lamp or multiple heating lamps) or other types of heating elements.

The controller 116 is able to control the operation of each of the printhead assembly 118, the heater assembly 122, and the spreader 120. The spreader 120 is movable along a generally horizontal axis (indicated as 124) over the build bed 112 to spread a layer of build material onto the build bed 112. In some cases, the spreader 120 can be moved in multiple orthogonal horizontal axes.

The controller 116 can also control movement of the printhead assembly 118 with respect to the build bed 112. The printhead assembly 118 can also be moved along a horizontal axis (or multiple horizontal axes). As the printhead assembly 118 is moved by the controller 116, the controller 116 can control the printhead assembly 118 to eject the liquid agent(s) 119.

At the appropriate time during a build operation (such as after the liquid agent(s) 119 has (have) been applied onto the layer of build material), the controller 116 can activate the heater assembly 122 to heat the layer of build material.

In accordance with some implementations of the present disclosure, the additive manufacturing machine 102 includes a contone level adjustment engine 130, which is able to provide contone adjustment information 132 to the controller 116 for the purpose of adjusting a contone level of the liquid agent(s) 119 supplied from the printhead assembly 118 onto each layer of build material on the build bed 112.

In FIG. 1, the contone level adjustment engine 130 is external of the controller 116. In other examples, the contone level adjustment engine 130 can be part of the controller 116.

The contone adjustment information 132 can specify a specific contone level to use during a build job, or alternatively, specify a delta contone value to apply that is added to or subtracted from a nominal contone level that is selected by the controller 116 to use based on the collection of digital representations of 3D parts 114. More generally, a contone level or a delta contone value can be referred to as a “contone mask value” that controls an adjustment of a contone level of the liquid agent(s) 119 during a build job. Note that the contone mask value can be applied to surface voxels (or shell voxels) of each respective 3D part. In other words, the contone level adjustment is not applied to the inner voxels of the respective 3D part, but is applied to the surface voxels of the respective 3D part. In other examples, the contone mask value can be applied to the surface voxels as well as to a given quantity of voxels adjacent to the surface voxels of the respective 3D part.

In some examples, the build bed 112 can be divided into multiple build regions, and the contone adjustment information 132 can specify different contone mask values to apply for the multiple build regions during the build job. For example, the contone adjustment information 132 can specify a first contone mask value for a first build region, a second contone mask value (which can be the same as or different from the first contone mask value) for a second build region, a third contone mask value (which can be the same as or different from the first contone mask value and/or the second contone mask value) for a third build region, and so forth.

The contone level adjustment engine 130 receives the contone adjustment model 106 from the contone adjustment model generation engine 104. The contone level adjustment engine 130 also receives adjustment information 134, which specifies geometrical adjustments that are to be applied to respective 3D parts 110 being built by the additive manufacturing machine 102.

A “geometric adjustment” refers to a modification amount of a geometrical property that produces a geometrical property value that is modified from a target geometrical property value. The target geometrical property value represents a geometrical property (e.g., size, thickness, curvature dimension, etc.) of a 3D part that is desired to be formed based on a digital representation of the 3D part (114). The geometric adjustment is to compensate for a variation from the target geometrical property value of the 3D part caused by a physical effect during a build operation of the additive manufacturing machine 102.

The adjustment information 134 can be derived based on building 3D parts by the additive manufacturing machine 102, and then determining deviations of geometrical properties the built 3D parts in different build regions from the target geometrical property value.

In response to a given geometric adjustment included in the adjustment information 134, the contone level adjustment engine 130 maps the given geometric adjustment using the contone adjustment model 106 to a corresponding contone mask value. For example, the contone adjustment model 106 correlates different contone levels to corresponding different geometrical deviations.

The contone level adjustment engine 130 can identify a geometrical deviation from among the different geometrical deviations that is closest to the given geometric adjustment, and identifies a contone level correlated by the contone adjustment model 106 to the identified geometrical deviation. The identified contone level can be used as a contone mask value included in the contone adjustment information 132 to be used by the controller 116 in controlling an amount of the liquid agent(s) 119 in a build operation for the 3D part.

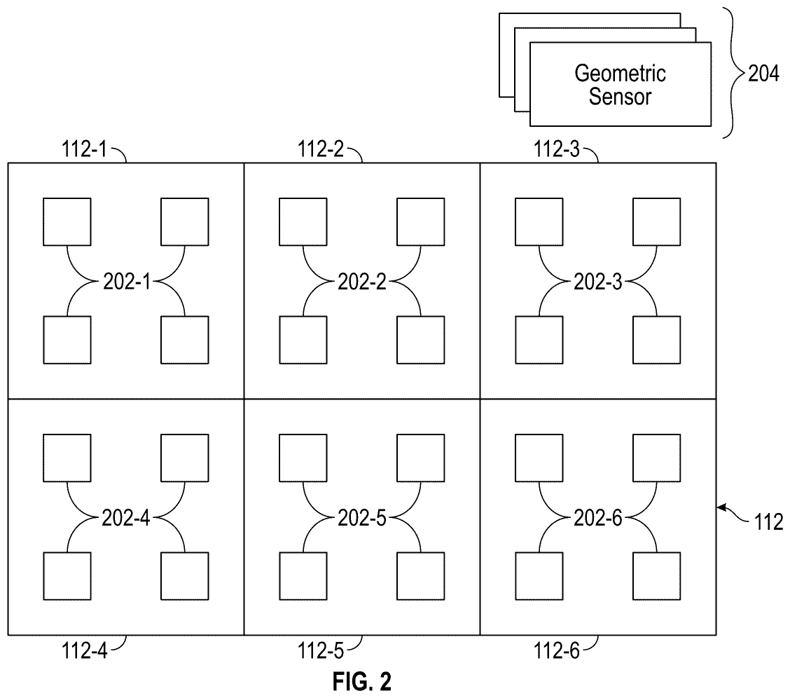

FIG. 2 is a schematic top view of test 3D parts 202-1 to 202-6 formed on an upper surface of the build bed 112. In some examples, the build bed 112 is divided into 6 different build regions 112-1, 112-2, 112-3, 112-4, 112-5, and 112-6. The test 3D parts 202-1 are formed in the build region 112-1, the test 3D parts 202-2 are formed in the build region 112-2, and so forth. Although FIG. 2 shows six build regions 112-1 to 112-6, in other examples, the build bed 112 can be divided into a different quantity of build regions. Also, a different quantity (less than 4 or greater than 4) of test 3D parts may be built in each respective build region.

In some examples, the test 3D parts created in the different build regions of the build bed 112 can be formed using different contone levels. For example, the test 3D parts 202-1 created in the build region 112-1 can use a first control level that controls an amount of a liquid agent (e.g., a fusing agent, a detailing agent, etc.) used in the build region 112-1, the test 3D parts 202-2 created in the build region 112-2 can use a second contone level (different from the first contone level), and so forth. Effectively, different control level masks can be specified for the different build regions 112-1 to 112-6. The different control level masks apply different contone levels in the respective build regions.

Once the test 3D parts 202-1 to 202-6 are built on the build bed 112, a collection of geometric sensors 204 (a single geometric sensor or multiple geometric sensors) can be used to measure a collection of geometrical properties (a single geometrical property or multiple geometrical properties) of each test 3D part. For example, a geometrical property measured by a geometric sensor 204 can be a size of a test 3D part. In other examples, a geometric sensor 204 can measure a different geometrical property of a test 3D part.

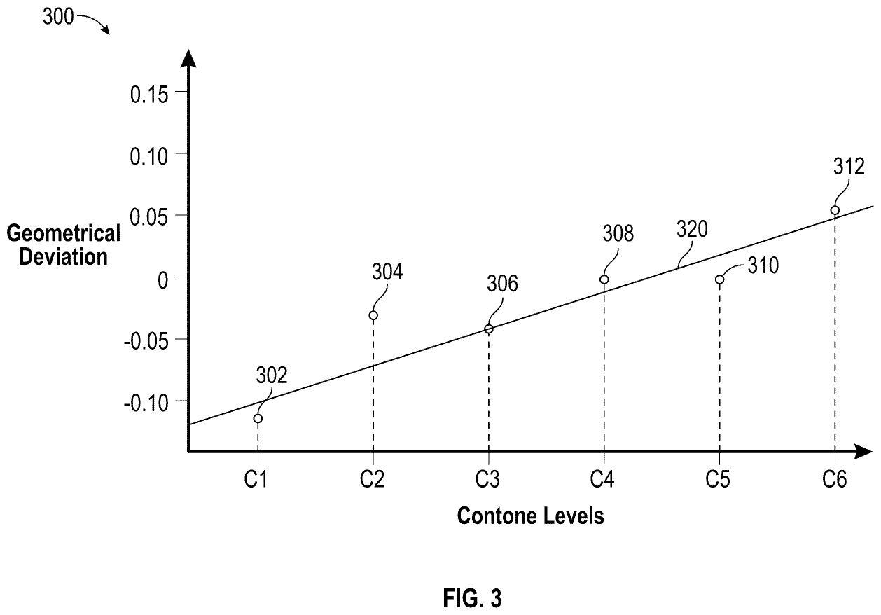

The measurement data (e.g., 108 in FIG. 1) collected by the collection of geometric sensors 204 is provided to the contone adjustment model generation engine 104 of FIG. 1. Based on the measurement data from the collection of geometric sensors 204, the contone adjustment model generation engine 104 can determine a relationship between different contone levels and geometrical deviations, such as according to FIG. 3.

FIG. 3 is a graph 300 that shows a relationship between contone levels (horizontal axis) and geometrical deviations (vertical axis). A point 302 correlates a geometrical deviation for a first contone level C1 (which may be applied in the build region 112-1 of FIG. 2, for example), a point 304 correlates a geometrical deviation for a contone level C2 (which may be applied in the build region 112-2 of FIG. 2, for example), a point 306 correlates a geometrical deviation for a contone level C3 (which may be applied in the build region 112-3 of FIG. 2, for example), a point 308 correlates a geometrical deviation for a contone level C4 (which may be applied in the build region 112-4 of FIG. 2, for example), a point 310 correlates a geometrical deviation for a contone level C5 (which may be applied in the build region 112-5 of FIG. 2, for example), a point 312 correlates a geometrical deviation for a contone level C6 (which may be applied in the build region 112-6 of FIG. 2, for example), and so forth.

A zero value of the geometrical deviation represents a baseline geometrical property. In an example where a geometrical property represented by the geometrical deviations of FIG. 3 is a size of a 3D part, a negative geometrical deviation value can indicate that a test 3D part built using the corresponding contone level results in a size that is less than a baseline size by the negative geometrical deviation value. A positive geometrical deviation value can indicate that a test 3D part built using the corresponding contone level results in a size that is greater than the baseline size by the positive geometrical deviation value.

To determine the baseline geometrical property, further test 3D parts can be formed in the build regions of a build bed without adjusting contone levels. For example, the same contone level can be used to form the further test 3D parts in the build regions. The collection of geometric sensors 204 (FIG. 2) can be used to collect further measurement data from measurements of the further test 3D parts formed on the build bed of the additive manufacturing machine 102 without varying a contone level of the liquid agent(s) 119. The contone adjustment model generation engine 104 can determine the baseline geometrical property based on the further measurement data.

In examples where multiple test 3D parts are built in each respective build region where a respective contone level is applied (one of C1 to C6), each point 302 to 312 represents an average geometrical deviation of the test 3D parts formed in the respective build region at the respective contone level.

In some examples, the contone adjustment model generation engine 104 can apply a regression based on the points 302 to 312. More specifically, a linear regression can be applied to the points 302 to 312 to form a line 320 that best fits the points 302 to 312. In other examples, a non-linear regression can be applied to the points 302 to 312 to form a curve that best fits the points 302 to 312.

The line 320 can be provided to the contone level adjustment engine 130 (FIG. 1) as the contone adjustment model 106.

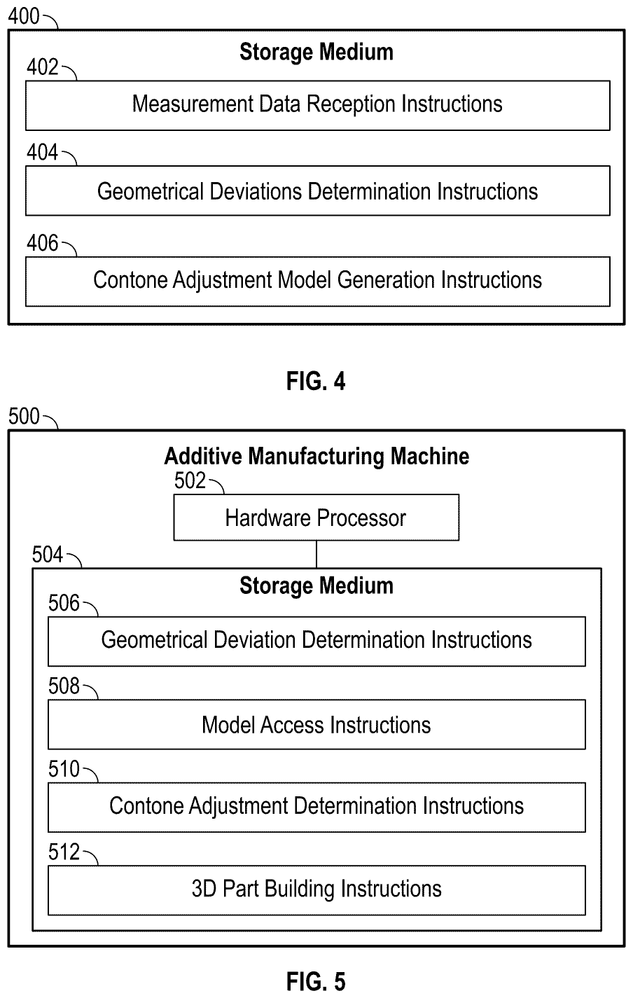

FIG. 4 is a block diagram of a non-transitory machine-readable or computer-readable storage medium 400 storing machine-readable instructions that upon execution cause a system to perform various tasks. The system may be a collection of computers (a single computer or multiple computers) separate from an additive manufacturing machine, or alternatively, the system may be the additive manufacturing machine.

The machine-readable instructions include measurement data reception instructions 402 to receive measurement data from measurements of first 3D parts formed on a build bed of an additive manufacturing machine with different contone levels of a liquid agent. As used here, the term “a liquid agent” can refer to a single liquid agent or multiple liquid agents. The first 3D parts can be test 3D parts formed in a calibration job.

The machine-readable instructions include geometrical deviations determination instructions 404 to determine, based on the measurement data, geometrical deviations of the first 3D parts from a baseline geometrical property.

The machine-readable instructions include contone adjustment model generation instructions 406 to generate, based on the determined geometrical deviations, a model that correlates contone levels of the liquid agent to corresponding geometrical deviations. The model is for use in an adjustment of the liquid agent based on a contone level adjustment to compensate for a geometrical deviation when building second 3D parts with the additive manufacturing machine or another additive manufacturing machine.

In some examples, the determining of the geometrical deviations of the first 3D parts from the baseline geometrical property includes determining size deviations of the first 3D parts from a baseline size.

In some examples, the determining of the geometrical deviations of the first 3D parts from the baseline geometrical property includes determining thickness deviations or curvature dimension deviations of the first 3D parts from a baseline size.

In some examples, the machine-readable instructions receive further measurement data from measurements of third 3D parts formed on a build bed of the additive manufacturing machine without varying a contone level of the liquid agent, and determine the baseline geometrical property based on the further measurement data.

In some examples, the different contone levels of the liquid agent are applied in respective different build regions of the build bed to form the first 3D parts, and the determining of the geometrical deviations of the first 3D parts from the baseline geometrical property includes comparing a geometrical property of a first 3D part formed in a first build region of the different build regions to the baseline geometrical property, and comparing a geometrical property of a second 3D part formed in a second build region of the different build regions to the baseline geometrical property.

In some examples, the generating of the model based on the determined geometrical deviations includes producing information that relates the different contone levels used to form the first 3D parts to the determined geometrical deviations (e.g., using the graph 300 of FIG. 3), and applying regression (e.g., a linear regression) on the information that relates the different contone levels to the determined geometrical deviations to generate the model.

In some examples, the adjustment of the liquid agent based on the contone level adjustment when building the second 3D parts performs a sub-voxel geometric adjustment.

FIG. 5 is a block diagram of an additive manufacturing machine 500 that includes a hardware processor 502 (or multiple hardware processors). A hardware processor can include a microprocessor, a core of a multi-core microprocessor, a microcontroller, a programmable integrated circuit, a programmable gate array, or another hardware processing circuit.

The additive manufacturing machine 500 includes a storage medium 504 that stores machine-readable instructions executable on the hardware processor 502 to perform various tasks. Machine-readable instructions executable on a hardware processor can refer to the instructions executable on a single hardware processor or the instructions executable on multiple hardware processors.

The hardware processor(s) 502 and the storage medium 504 can be part of the controller 116 of FIG. 1 for example.

The machine-readable instructions in the storage medium 504 include geometrical deviation determination instructions 506 to determine a geometrical deviation of a geometrical property relating to a first 3D part to be formed by an additive manufacturing machine.

The machine-readable instructions in the storage medium 504 include model access instructions 508 to access a model that correlates contone levels of a liquid agent to corresponding geometrical deviations of 3D parts.

The machine-readable instructions in the storage medium 504 include contone adjustment determination instructions 510 to determine, based on the model, a contone level of the liquid agent for the first 3D part. The determined contone level is to compensate for the determined geometrical deviation.

The machine-readable instructions in the storage medium 504 include 3D part building instructions 512 to control building of the first 3D part by the additive manufacturing machine using the determined contone level of the liquid agent that compensates for the determined geometrical deviation.

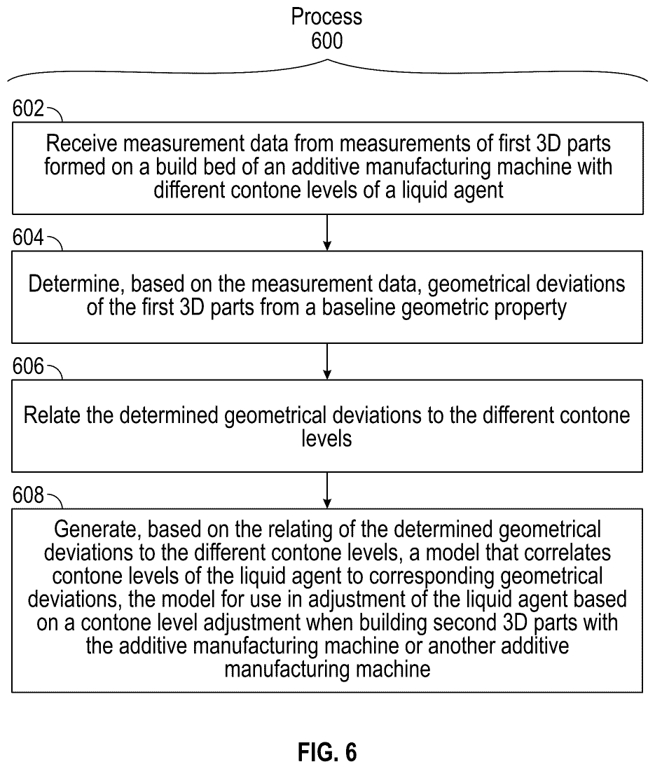

FIG. 6 is a flow diagram of a process 600 according to some examples, which may be performed by the contone adjustment model generation engine 104, for example.

The process 600 includes receiving (at 602), at a system comprising a hardware processor, measurement data from measurements of first 3D parts formed on a build bed of an additive manufacturing machine with different contone levels of a liquid agent.

The process 600 includes determining (at 604), by the system based on the measurement data, geometrical deviations of the first 3D parts from a baseline geometrical property.

The process 600 includes relating (at 606), by the system, the determined geometrical deviations to the different contone levels.

The process 600 includes generating (at 608), by the system based on the relating of the determined geometrical deviations to the different contone levels, a model that correlates contone levels of the liquid agent to corresponding geometrical deviations, the model for use in adjustment of the liquid agent based on a contone level adjustment when building second 3D parts with the additive manufacturing machine or another additive manufacturing machine.

A storage medium (e.g., 400 in FIG. 4 or 504 in FIG. 5) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory or other type of non-volatile memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1.-15. (canceled)

16. A non-transitory machine-readable storage medium comprising instructions executable by a system to perform processing comprising:
receiving measurement data from measurements of first three-dimensional (3D) parts formed on a build bed of an additive manufacturing machine with different contone levels of a liquid agent;
determining, based on the measurement data, geometrical deviations of the first 3D parts from a baseline geometrical property; and
generating, based on the determined geometrical deviations, a model that correlates contone levels of the liquid agent to corresponding geometrical deviations,
wherein the model provides for an adjustment of the liquid agent based on a contone level adjustment to compensate for the determined geometrical deviations when building second 3D parts with the additive manufacturing machine or another additive manufacturing machine,
and wherein the adjustment of the liquid agent based on the contone level adjustment when building the second 3D parts includes a sub-voxel geometric adjustment.

17. The non-transitory machine-readable storage medium of claim 16, wherein the first 3D parts are test 3D parts formed by the additive manufacturing machine as part of a calibration job.

18. The non-transitory machine-readable storage medium of claim 16, wherein the different contone levels of the liquid agent are applied in respective different build regions of the build bed to form the first 3D parts.

19. The non-transitory machine-readable storage medium of claim 16, wherein determining the geometrical deviations of the first 3D parts from the baseline geometrical property comprises determining size deviations of the first 3D parts from a baseline size.

20. The non-transitory machine-readable storage medium of claim 16, wherein determining the geometrical deviations of the first 3D parts from the baseline geometrical property comprises determining thickness deviations or curvature dimension deviations of the first 3D parts from a baseline size.

21. The non-transitory machine-readable storage medium of claim 16, wherein the processing further comprises:
receiving further measurement data from measurements of third 3D parts formed on the build bed of the additive manufacturing machine without varying a contone level of the liquid agent; and
determining the baseline geometrical property based on the further measurement data.

22. The non-transitory machine-readable storage medium of claim 21, wherein the baseline geometrical property comprises a size of each third 3D part of the third 3D parts.

23. The non-transitory machine-readable storage medium of claim 21, wherein the different contone levels of the liquid agent are applied in respective different build regions of the build bed to form the first 3D parts, and
wherein determining the geometrical deviations of the first 3D parts from the baseline geometrical property comprises:
comparing a geometrical property of a first 3D part formed in a first build region of the different build regions to the baseline geometrical property, and
comparing a geometrical property of a second 3D part formed in a second build region of the different build regions to the baseline geometrical property.

24. The non-transitory machine-readable storage medium of claim 23, wherein generating the model based on the determined geometrical deviations comprises:
producing information that relates the different contone levels used to form the first 3D parts to the determined geometrical deviations, and
applying regression on the information that relates the different contone levels to the determined geometrical deviations to generate the model.

25. The non-transitory machine-readable storage medium of claim 24, wherein the regression comprises a linear regression.

26. The non-transitory machine-readable storage medium of claim 16, wherein the processing further comprises:
causing the additive manufacturing machine or the other additive manufacturing to build the second 3D parts in accordance with the generated model.

27. An additive manufacturing machine comprising:
a processor; and
a non-transitory storage medium storing instructions executable on the processor to perform processing comprising:
determining a geometrical deviation of a geometrical property relating to a first three-dimensional (3D) part formed by the additive manufacturing machine or another additive manufacturing machine;
accessing a model that correlates contone levels of a liquid agent to corresponding geometrical deviations of 3D parts;
determining, based on the model, a contone level of the liquid agent for the first 3D part, the determined contone level to compensate for the determined geometrical deviation; and
controlling building of a second 3D part by the additive manufacturing machine using the determined contone level of the liquid agent that compensates for the determined geometrical deviation,
wherein compensation for the determined geometrical deviation comprises a sub-voxel adjustment of the geometrical property of the first 3D part.

28. The additive manufacturing machine of claim 27, wherein the first 3D part is a test 3D part formed by the additive manufacturing machine or the other additive manufacturing machine as part of a calibration job.

29. The additive manufacturing machine of claim 27, wherein determining the geometrical deviation comprises determining a size deviation of the first 3D part from a baseline size.

30. The additive manufacturing machine of claim 27, wherein determining the geometrical deviation comprises determining a thickness deviation or a curvature dimension deviation of the first 3D part from a baseline size.

31. A method comprising:
receiving, by a hardware processor, measurement data from measurements of first three-dimensional (3D) parts formed on a build bed of an additive manufacturing machine with different contone levels of a liquid agent;
determining, by the hardware processor and based on the measurement data, geometrical deviations of the first 3D parts from a baseline geometrical property;
relating, by the hardware processor, the determined geometrical deviations to the different contone levels; and
generating, by the hardware processor and based on the relating of the determined geometrical deviations to the different contone levels, a model that correlates contone levels of the liquid agent to corresponding geometrical deviations,
wherein the model provides for an adjustment of the liquid agent based on a contone level adjustment to compensate for the determined geometrical deviations when building second 3D parts with the additive manufacturing machine or another additive manufacturing machine,
and wherein the adjustment of the liquid agent based on the contone level adjustment when building the second 3D parts includes a sub-voxel geometric adjustment.

32. The method of claim 31, further comprising:
receiving, by the hardware processor, further measurement data from measurements of third 3D parts formed on the build bed of the additive manufacturing machine without varying a contone level of the liquid agent; and
determining, by the hardware processor, the baseline geometrical property based on the further measurement data.

33. The method of claim 31, wherein the different contone levels of the liquid agent are applied in respective different build regions of the build bed to form the first 3D parts, and
wherein determining the geometrical deviations of the first 3D parts from the baseline geometrical property comprises:
comparing a geometrical property of a first 3D part formed in a first build region of the different build regions to the baseline geometrical property, and
comparing a geometrical property of a second 3D part formed in a second build region of the different build regions to the baseline geometrical property.

34. The method of claim 33, wherein generating the model based on the determined geometrical deviations comprises:
producing information that relates the different contone levels used to form the first 3D parts to the determined geometrical deviations, and
applying regression on the information that relates the different contone levels to the determined geometrical deviations to generate the model.

35. The method of claim 31, further comprising:
causing the additive manufacturing machine or the other additive manufacturing to build the second 3D parts in accordance with the generated model.
